(19) United States
(12) Patent Application Publication
(10) Pub. No.: US 2004/0044549 A1
(43) Pub. Date: Mar. 4, 2004

(54) Method of determining potential for repair services in a geographic area

(76) Inventor: Kevin S. Loop, Medina, OH (US)

Correspondence Address: PPG INDUSTRIES, INC., Intellectual Property Department, One PPG Place, Pittsburgh, PA, 15272, US

(21) Appl. No.: 10/231,502

(22) Filed: Aug. 30, 2002

(51) Int. Cl. G06F 17/60

(52) U.S. Cl. 705/4

(57) ABSTRACT

A method of determining the market value of a repair service on an insured article having the steps of (a) determining the likelihood (L) of filing an insurance claim on insured articles in a geographic area; (b) determining a dollar value (V) for an insurance claim on the article in the geographic area; (c) determining a quantity factor (Q) related to the quantity of the articles in the geographic area; and (d) calculating the total potential sales value (S) of insurance claims on the based on (a), (b) and (c). The insured articles may be vehicles in geographic areas corresponding to zip codes.

### BACKGROUND OF THE INVENTION

1. Field of the Invention

The present invention relates to a method of determining the potential demand for repair services in a geographic area, more particularly, to determining the market value of a repair service on insured articles in a plurality of geographic areas.

2. Prior Art

Marketing of repair services requires understanding the customer base for the repair services. For example, in automotive collision repair services, important information required to determine and implement effective marketing tools include identifying the location of the customers who need collision repair services the most, identifying current customers and potential customers, characterizing the customers' purchasing habits, identifying marketing programs that target and reach those customers, and identifying potential future changes in the geographic area of the repair services. Traditionally, a collision repair shop markets its services in geographic areas which immediately surround the shop and which are within a marketing budget for the shop. Due to a lack of specific information about the customers in the surrounding area of the repair shop, the marketing efforts are typically delivered uniformly across the area. For example, a repair shop may send advertising literature to all households in a five mile radius area. This tactic does not account for the buying potential for those households. While such a blanket approach will address the customers with the highest buying potential, it includes a significant amount of wasted time and effort for some customers whose potential for using the collision repair services of the shop are minimal.

Accordingly, a need remains for a method of determining the sales potential for automotive repair services and other repair services in a geographic area to allow for targeted marketing of services for repairing insured articles

### SUMMARY OF THE INVENTION

This need is met by the method of the present invention of determining the market value of a repair service on an insured article. According to the method, (a) the likelihood of filing an insurance claim on insured articles (L), such as vehicles, is determined in at least one geographic area, also (b) the dollar values (V) for insurance claims on the insured articles in the geographic areas are determined; finally, (c) the quantity of the articles in the geographic area is related to a quantity factor (Q), such as the number of households, the total population of persons using such an article (such as all adults), or the number of insured articles is determined. The potential sales value (S) of insurance claims on the articles in the geographic area is then determined from a consideration of (a), (b) and (c) such as by the calculation of S=L×V×Q. The method may be performed on several geographic areas, such as zip codes, to identify which geographic area (zip code) has the highest potential sales value.

Within each geographic area, a demographic profile may be determined to identify demographic clusters that are most common in the geographic area. The demographic information may be used to target those demographic clusters.

In certain instances, the likelihood of filing an insurance claim (L) in a particular geographic area is so high that although the potential sales value is lower than in another geographic area, it may be beneficial to prioritize the market value of the geographic areas based on both the total potential sales value (S) and the likelihood of filing an insurance claim (L). It is also possible to determine a change in the quantity factors (Q) over time to calculate the future potential sales values (V) for the geographic areas. This information is helpful in determining where to institute marketing tools in the future and/or locate additional shops for repair services.

A complete understanding of the invention will be obtained from the following description when taken in connection with the accompanying drawing figures wherein like reference characters identify like parts throughout.

### BRIEF DESCRIPTION OF THE DRAWINGS

FIG. 1 is a map of selected set of zip code geographic areas showing the likelihood of filing an insurance claim in each area; and

FIG. 2 is a map of the geographic areas shown in FIG. 1 showing the potential sales value of insurance claims on the articles.

### DETAILED DESCRIPTION OF THE INVENTION

For the purposes of the description hereinafter, it is to be understood that the invention may assume various alternative variation step sequences, except where expressly specified to the contrary. It is also to be understood that the specific information illustrated in the attached drawings and described in the following specification are simply exemplary embodiments of the invention.

The present invention relates generally to a method for determining the potential demand for repair services on insured articles in a geographic area. In the following discussion, the method is explained with reference to determining the market value of automotive collision services. However, it is to be understood that this is an exemplary use of the invention and should not be considered as limiting. The method of the present invention can be practiced in a variety of fields, such as repair services for insured buildings (e.g. homes and businesses) or other insured articles.

According to the present invention, the method of determining the market value of a repair service on insured articles, such as vehicles, includes a step of determining the likelihood (L) of filing an insurance claim on insured articles in a geographic area. A suitable geographic area is the area of one zip code. Other suitable geographic areas may be the boundaries of a city, a suburb, or an area bounded by natural features, such as waterways or mountains. Areas as large as entire states, metropolitan statistical areas, minor civil divisions and designated marketing areas or as small as census units such as tracts and block groups may be evaluated. The present invention may be applicable to a single geographic area or to a plurality of geographic areas to facilitate comparing the potential sales value for repair services between the geographic areas.

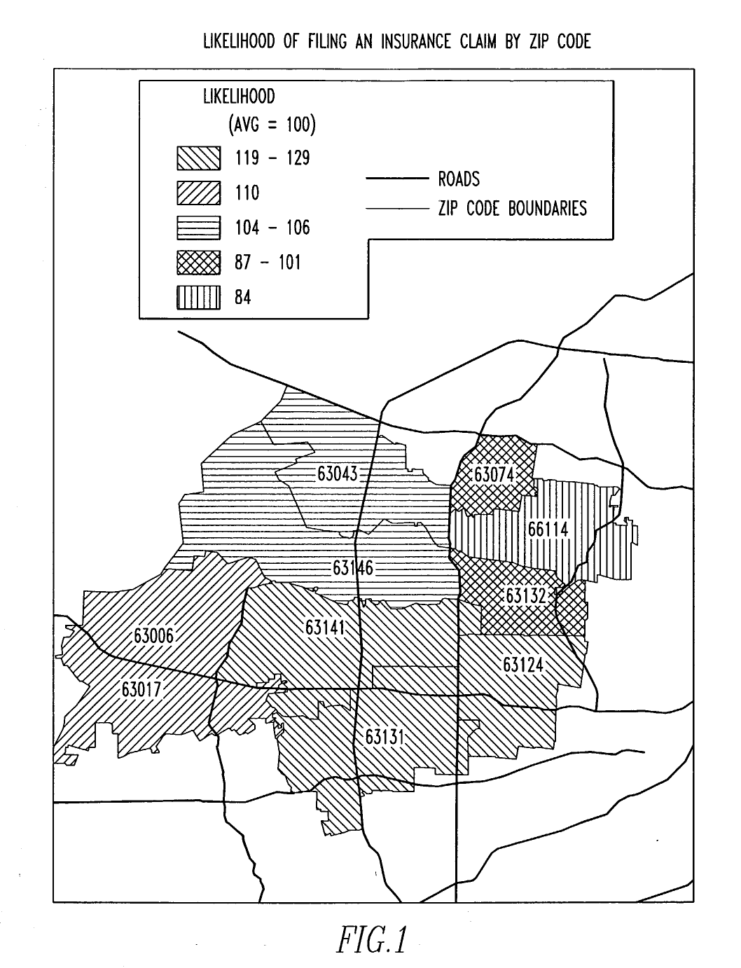

FIG. 1 shows an exemplary map of ten geographic areas (by zip code) in a locality. Each zip code in the locality has assigned thereto a likelihood (L) of filing an insurance claim on an insured article, such as a vehicle, with the average likelihood (L) equal to 100. For certain zip codes, the likelihood (L) may be greater than 100, meaning that the likelihood (L) of filing an insurance claim is higher in that zip code than in a zip code having an index of less than 100. By identifying the geographic areas, such as zip codes, with the highest likelihood (L) of filing insurance claims, a collision repair shop may determine that marketing for the shop should be instituted in that area.

A dollar value (V) for an insurance claim on an article in the geographic area is also calculated. The value per insurance claim of an insured article may be known or calculated as an average in a geographic region. For example, the total value of collision repair services in the United States presently is about 25 billion dollars. When that country-wide value is divided by the total number of claims filed in the United States, an average value of an insurance claim for repair of a vehicle may be calculated.

In order to determine the total potential sales value on an insurance claim on the articles in the geographic area a quantity factor (Q) relating to the quantity of the articles in the geographic area is determined. For collision repair services, the quantity factor (Q) may be the number of households, the adult population (the potential owners of vehicles) or the actual number of vehicles in the geographic area. The number of households or number of adults may be available from census data. The number of insured vehicles may be available from the insurance industry. The total potential sales value of an insurance claim on an article in the geographic area is calculated by multiplying the likelihood (L) of filing an insurance claim on an insured article in the geographic area by a quantity factor (Q) related to the quantity of the articles and the previously calculated dollar value (V) for each insurance claim or according to the formula S=L×Q×V.

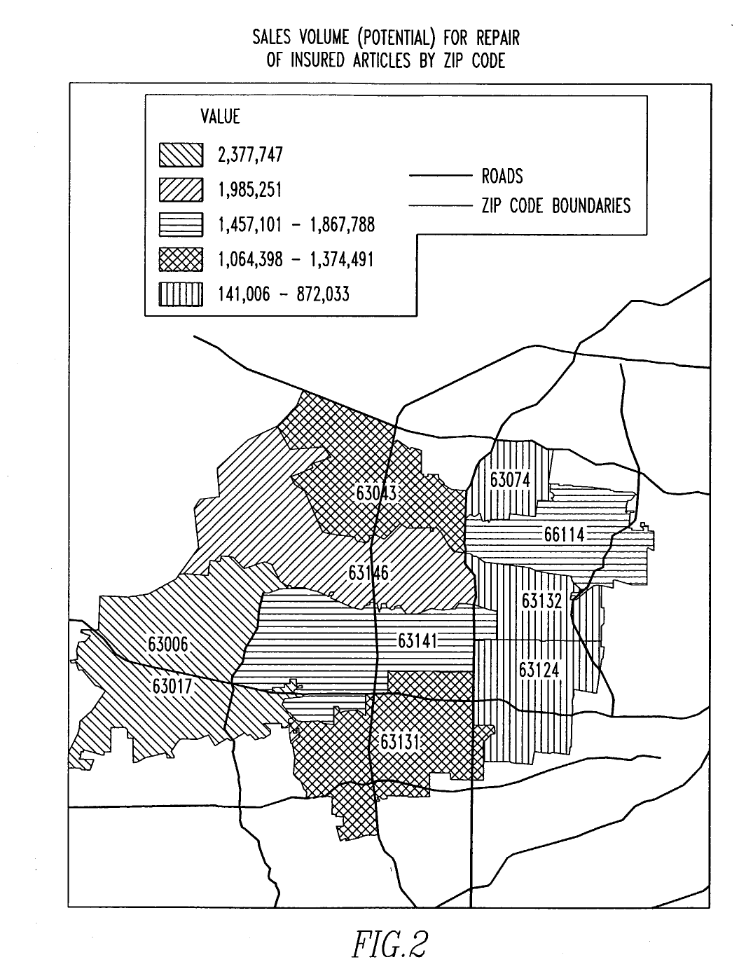

FIG. 2 is a map of the same locality shown in FIG. 1 showing the total potential sales value (S) of insurance claims on the articles in each zip code. An owner of a repair service may seek to target areas with the likelihood (L) of filing an insurance claim as shown in FIG. 1 or the highest potential for repair sales (S) as shown in FIG. 2 depending on the type of marketing strategy under consideration and other factors, such as the size of the repair shop's trading area, the business's strengths and weaknesses, the competition and the like. With this information, a repair shop owner may determine whether to pursue the greatest number of customers with the greatest overall sales potential (S) or if the market should be segmented differently based on high likelihood (L) or proximity to an existing repair services shop.

Additional demographic information may be used to refine the total potential sales value (S) in a geographic area. Demographic information which is available for a geographic area may be used to identify marketing strategies that would be appropriate for a certain demographic profile within that geographic area. Certain demographic information including socioeconomic indicators are associated with behavioral traits. For example, a geographic area (or a portion thereof) having a cluster of high income households may be expected to also have a high concentration of luxury vehicles that are generally immediately repaired upon suffering damage. A collision repair shop's marketing strategy to meet the needs of this population may be adapted accordingly. Advertising may be targeted for certain forms of print media or on-line media that a cluster of high income households are most likely to view. In contrast, if the demographic profile of a geographic area (or a portion thereof) indicates a high number of low or middle income households, then a marketing strategy may be adopted which addresses that segment of the population.

The method of the present invention may be further refined by using models for determining changes in the population, number of households, and/or insured articles in the geographic area and determining an associated change in the quantity factors (Q) over time to calculate future potential sales values for the geographic areas. This information is particularly useful in determining where to focus marketing strategies in the future and/or identifying locations for potential new repair service shops.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

I claim:

1. A method of determining the market value of a repair service on an insured article comprising the steps of:
(a) determining the likelihood (L) of filing an insurance claim on insured articles in a geographic area;
(b) determining a dollar value (V) for an insurance claim on the article in the geographic area;
(c) determining a quantity factor (Q) related to the quantity of the articles in the geographic area;
(d) determining the potential sales value (S) of insurance claims on the articles in the geographic area based on (a), (b) and (c).

2. The method of claim 1, wherein said step of determining the potential sales value (S) is calculated according to the formula S=L×V×Q.

3. The method of claim 1, wherein the quantity factor is a number of units in the geographic area, the units being selected from the group consisting of households, population, and insured articles.

4. The method of claim 2, wherein the insured articles are vehicles.

5. The method of claim 1, wherein step (a)-(d) are performed on a plurality of geographic areas.

6. The method of claim 5, wherein each geographic area is an area of a zip code.

7. The method of claim 5 further comprising a step of prioritizing the market value of the geographic areas based on the total potential sales value (S) and the likelihood (L) of filing an insurance claim.

8. The method of claim 5 further comprising a step of determining a demographic profile for the population in each geographic area, and identifying a marketing strategy for the population of the geographic areas based on the value (S) and the demographic profile.

9. The method of claim 5 further comprising a step of determining the change in quantity factors (Q) over time and predicting the future change in quantity factors (Q) to calculate future total potential sales values (S) for the geographic areas.
